(19) United States
(12) Patent Application Publication
(10) Pub. No.: US 2026/0100863 A1
(43) Pub. Date: Apr. 9, 2026

(54) COLLISION AVOIDANCE FOR A COMMUNICATION NETWORK

(71) Applicant: Infineon Technologies AG, Neubiberg (DE)

(72) Inventors: Daniel Mysliwitz, Unterschleißheim (DE); Vivin Richards Allimuthu Elavarasu, Taufkirchen (DE)

(21) Appl. No.: 19/350,147

(22) Filed: Oct. 6, 2025

(30) Foreign Application Priority Data
Oct. 8, 2024 (DE) 102024209812.4

(51) Int. Cl. H04L 12/413; H04L 12/40

(52) U.S. Cl. CPC H04L 12/413; H04L 12/40143

(57) ABSTRACT

A mechanism for determining a transmit order sequence for inter-device communication within a communication network that facilitates one of the devices to operate in a priority mode. If the communication network operates in a priority mode and the device has a particular priority value, the device is provided with more than one transmit opportunity within a transmit order sequence. If the device does not have the particular priority value, the device is provided with a single transmit opportunity within the transmit order sequence.

### REFERENCE TO RELATED APPLICATION

This application claims priority to German Application number 102024209812.4, filed on Oct. 8, 2024, the contents of which are hereby incorporated by reference in their entirety.

### TECHNICAL FIELD

The present disclosure relates to communication networks, and in particular, to collision avoidance techniques for use in communication networks.

### BACKGROUND

A number of communication networks comprise multiple electronic devices sharing a common communication medium to transmit data. In such networks, data collisions may occur when two or more devices attempt to transmit simultaneously, leading to data corruption and reduced network efficiency. To address this issue, collision avoidance techniques, particularly PHY-level Collision Avoidance techniques, have been developed.

Some existing collision avoidance methods employ a time-division approach to facilitate communication on a shared communication medium. In this approach, each device is assigned a specific time slot or position (known as a transmit opportunity) in a transmit order sequence during which it is permitted to communicate or initiate communications. This approach may include the use of a beacon signal to synchronize devices and coordinate communications, such that the beacon signal functions as a heartbeat for inter-device communication.

One known example of a suitable communication protocol that operates in this manner is the 10BASE-T1S protocol or standard, e.g., set out in the IEEE 802.3 cg standard. In such approaches, the shared communication medium may, for instance, be an Ethernet cable.

There is an ongoing desire for improved and more flexible communication techniques for performing inter-device communication over a shared/common communication medium.

### SUMMARY

There is herein proposed a collision avoidance module for an electronic device of a communication network, wherein the electronic device is configured to only transmit data to one or more other electronic devices of the communication network over a shared communication medium during any transmit opportunities for the electronic device.

The collision avoidance module is configured to: store a priority mode indicator indicating whether or not the communication network is operating in a priority mode; store a priority value; determine, as a respective device position, a position in a transmit order sequence for each of one or more transmit opportunities for the electronic device, wherein each determined device position for the electronic device avoids conflict with any device position for any transmit opportunity of any of the one or more other electronic devices; and responsive to a beacon signal over the shared communication medium, step through the transmit order sequence.

The collision avoidance module is configured to, when the priority mode indicator indicates that the communication network is operating in the priority mode: responsive to the stored priority value having one of a set of one or more first values, determine the one or more transmit opportunities to be only a single transmit opportunity; and responsive to the stored priority value having a second value, different to any of the set of one or more first values, determine the one or more transmit opportunities to be a plurality of transmit opportunities.

There is also herein proposed a computer-implemented method for determining transmit opportunities for an electronic device, wherein the electronic device is configured to only transmit data to one or more other electronic devices of the communication network over a shared communication medium during a transmit opportunity for the electronic device.

The computer-implemented method includes: storing a priority mode indicator indicating whether or not the communication network is operating in a priority mode; storing a priority value; determining, as a respective device position, a position in a transmit order sequence for each of one or more transmit opportunities for the electronic device, wherein each determined device position for the electronic device avoids conflict with any device position for any transmit opportunity of any of the one or more other electronic devices; and responsive to a beacon signal over the shared communication medium, stepping through the transmit order sequence.

The computer-implemented method comprises, when the priority mode indicator indicates that the communication network is operating in the priority mode: responsive to the stored priority value having one of a set of one or more first values, determining the one or more transmit opportunities to be only a single transmit opportunity; and responsive to the stored priority value having a second value, different to any of the set of one or more first values, determining the one or more transmit opportunities to be a plurality of transmit opportunities.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a communication network.

FIG. 2 illustrates an example transmit order sequence.

FIG. 3 illustrates a proposed method.

FIG. 4 illustrates a transmit order sequence resulting from the proposed method.

FIG. 5 illustrates another transmit order sequence resulting from the proposed method.

FIG. 6 illustrates another transmit order sequence resulting from the proposed method.

FIG. 7 illustrates another transmit order sequence resulting from the proposed method.

FIG. 8 illustrates another transmit order sequence resulting from the proposed method.

FIG. 9 illustrates another transmit order sequence resulting from the proposed method.

FIG. 10 illustrates a portion of an electronic device.

### DETAILED DESCRIPTION

The examples described herein provide a mechanism for determining a transmit order sequence for inter-device communication within a communication network that facilitates one of the devices to operate in a priority mode. If the communication network operates in a priority mode and the device has a particular priority value, the device is provided with more than one transmit opportunity within a transmit order sequence. If the device does not have the particular priority value, the device is provided with a single transmit opportunity within the transmit order sequence.

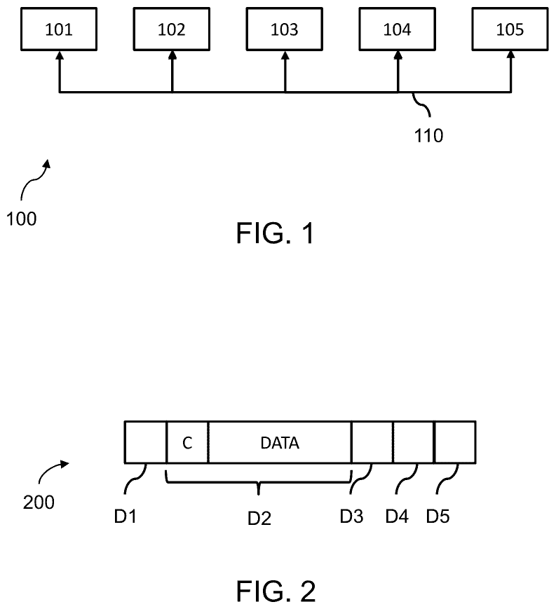

FIG. 1 illustrates a communication network 100 in which proposed embodiments may be employed, for the sake of improved contextual understanding.

The communication network 100 comprises a plurality of electronic devices 101, 102, 103, 104, 105 that are configured to communicate over a same, shared communication medium 110.

The communication medium 110 may, for instance, comprise a single cable such as an Ethernet cable. The shared communication medium effectively acts as a bus for facilitating external communication from each electronic device.

By way of working example, the communication network 100 may be a sensor network, in which at least some of the electronic devices comprise a sensor for monitoring an external parameter (e.g., temperature, user interaction, motion etc.). Values monitored by each sensor may be transmitted over the communication network, e.g., to a particular one of the electronic devices.

There is a desire for each electronic device 101, 102, 103, 104, 105 of the communication network 100 to make use of a collision avoidance technique, to prevent or avoid different electronic devices attempting to communicate over the shared communication medium at a same time. This is because simultaneous attempts to transmit data from different devices can corrupt or introduce noise into the transmitted data. In other words, a half-duplex communication protocol or technique should be employed.

For each electronic device, a collision avoidance module is used to coordinate or control communications using a collision avoidance technique to minimize or reduce a risk of data collision over the communication medium 110.

In some known or existing communication protocols, such as the one defined by the 10BASE-T1S protocol or standard (e.g., defined by the IEEE 802.3 cg standard(s)), each electronic device is effectively associated with a different device position. The device position defines a position within a transmit order sequence for the electronic device. When a beacon signal is sent over the communication medium, each electronic device will step through the transmit order sequence until it reaches its associated device position. The beacon signal thereby functions as a heartbeat for the communication protocol. The electronic device then has a transmit opportunity, during which it is permitted to begin or initiate the transmission of data. More particularly, the electronic device is configured to only transmit data to one or more other electronic devices of the communication network over the shared communication medium during the transmit opportunity for the electronic device. When the transmit opportunity has elapsed, the electronic device continues to move through the transmit order sequence as appropriate. The beacon signal will be retransmitted each time the transmit order sequence is complete. The beacon signal(s) may be transmitted or broadcast by a coordinating one 101 of the electronic devices 101, 102, 103, 104, 105 (which is sometimes known as a host device or a coordinating device).

In some known approaches, each electronic device may step through the transmit order sequence by, for each position in the sequence, waiting a predetermined period of time (which can be labelled a transmit opportunity duration), e.g., a certain number of clock cycles or frames, before moving to the next position in the transmit order sequence. If any electronic device wishes to transmit data, then it may transmit or broadcast a commit communication (which can be simply labelled a “commit”) during its transmit opportunity to reserve the communication medium for transmission of (some) data. Typically, a commit will only be able to reserve the communication medium for a second predetermined period of time, at least to permit urgent communications from other electronic devices to be transmitted. Correspondingly, if a commit is received or detected by an electronic device, from another electronic device, then it will (further) delay the stepping through the transmit order sequence for the second predetermined period of time. Thus, transmission of data will be delayed if a commit signal is identified.

The above described approach is also, in the context of an Ethernet communication protocol defined by the IEEE 802.3cg-2019 standard, known as a PHY-Level Collision Avoidance (PLCA) scheme. Similarly, a collision avoidance module may be labelled a PLCA module or simply a PLCA.

FIG. 2 illustrates an example transmit order sequence 200, through which each electronic device steps responsive to a beacon signal on the shared communication medium. The transmit order sequence includes a respective device position D1, D2, D3, D4, D5 for each electronic device, which determines a transmit opportunity for the respective electronic device. Each transmit opportunity has a first predetermined length of time (i.e. a first predetermined duration).

In the illustrated example, one of the electronic devices transmits a commit C during its corresponding transmit opportunity. This commit acts to reserve the communication medium, for said electronic device, for a second predetermined period of time (i.e., a second predetermined duration). The electronic device may then transmit data, i.e., a data communication, DATA during this second predetermined period of time.

The second period of time effectively acts or functions to extend the length or duration of the transmit opportunity for the device that transmits the commit during the transmit opportunity, to facilitate the transmission of data.

It is herein recognized that if an electronic device wishes to communicate or transmit a large amount of data, then the electronic device may require more than one iteration of the transmit order sequence (providing the opportunity for each other electronic device to communicate in turn) to transmit or otherwise communicate the data.

The present disclosure proposes introducing a priority mechanism into a collision avoidance technique employed by electronic devices of a communication network. The proposed priority mechanism provides an electronic device (operating in a priority device mode) with more than one transmit opportunity per transmit order sequence. In other words, an electronic device operating in a priority device mode (i.e., a priority device) is provided with a plurality of device positions in the transmit opportunity, affording it more than one transmit opportunity for each iteration of the transmit order sequence.

The proposed approach increases the frequency and/or number of transmit opportunities provided to a device operating in a priority device mode. This, for instance, facilitates faster transmission of a large amount of data and/or permit the electronic device to more quickly communicate the occurrence of one or more events at the electronic device.

Conceptually, there is proposed a priority device mode (which is defined on a per device basis) and a priority mode (which is defined for the entire network). An electronic device is operable in a priority device mode in which it is provided with a plurality of transmit opportunities. A communication network operates in a priority mode only when at least one electronic device operates in the priority device mode. Thus, the priority mode indicates whether or not at least one electronic device of the communication network operates in the priority device mode.

An electronic device that operates in a priority device mode may be labelled a priority device, for the sake of conciseness.

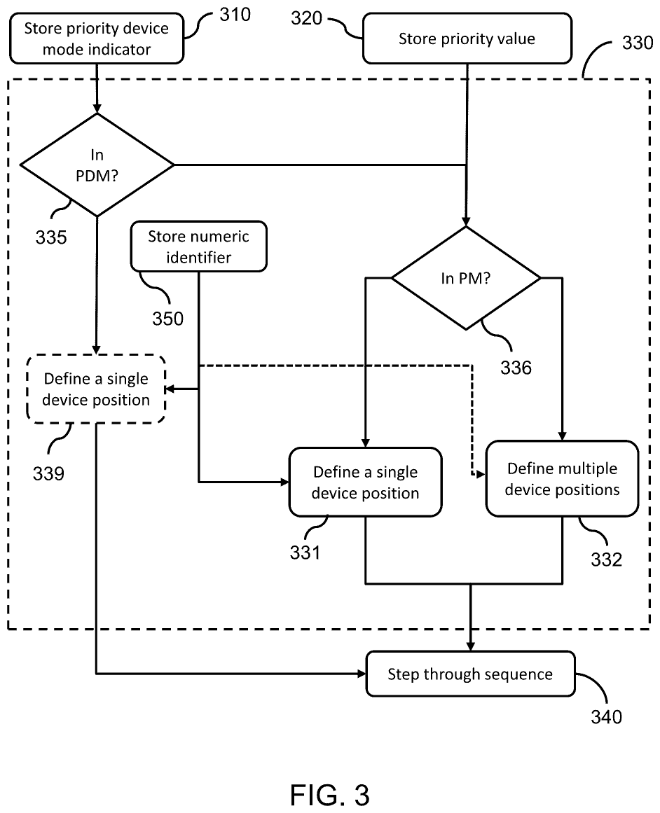

FIG. 3 is a flowchart illustrating a computer-implemented method 300 for determining transmit opportunities for an electronic device. The computer-implemented method 300 may, for instance, be carried out by a collision avoidance module for an electronic device.

The method 300 comprises a step 310 of storing a priority mode indicator (PMI). The priority mode indicator indicates whether or not the communication network is operating in a priority mode (PDM).

In this context, the communication network is switchably operable in a priority mode. When operating in the priority mode, at least one electronic device operates in a priority device mode, as later described. When not operating in the priority mode, then none of the electronic device(s) operates in a priority device mode.

The method 300 also comprises a step 320 of storing a priority value. As later explained in context, the priority value indicates whether the electronic device (for which the method is performed) operates in the priority device mode. The priority value may take one of a set of one or more first values or a second value. Each first value identifies that one of the one or more other electronic devices is the priority device (i.e., the electronic device is not the priority device). A second value of the priority value indicates that the electronic device is the priority device.

The priority value may, for instance, comprise a binary indicator of whether or not the electronic device operates in the priority device mode, i.e., whether or not the electronic device is a priority device. In this case, the set of one or more first values comprises a single value indicating that the electronic device is not operating in the priority device mode (i.e., is not a priority device). The second value of the priority value indicates that the electronic device is the priority device.

As another example, the priority value may comprise an identifier of the electronic device that operates in the priority device mode. In this case, the set of one or more first values comprises a same number of first values as other electronic devices in the communication network. Each first value identifies which of the one or more other electronic devices is the priority device. The second value of the priority value indicates that the electronic device is the priority device.

The method 300 also comprises a step 330 of determining, as a respective device position, a position in a transmit order sequence for each of one or more transmit opportunities for the electronic device. Each determined device position for the electronic device avoids conflict with any device position for any transmit opportunity of any of the one or more other electronic devices.

More particularly, step 330 comprises a sub-step 335 of determining whether or not the priority mode indicator indicates that the communication network is operating in the priority mode. Responsive to a positive determination in sub-step 335 (i.e., the priority mode indicator indicates that the communication network is operating in the priority mode), the method performs sub-step 331 or sub-step 332.

Sub-step 331 comprises, responsive to the stored priority value having one of a set of one or more first values, determining the one or more transmit opportunities to be only a single transmit opportunity. Thus, sub-step 331 is performed if the electronic device is not a priority device.

Sub-step 332 comprises, responsive to the stored priority value having a second value, different to any of the set of one or more first values, determining the one or more transmit opportunities to be a plurality of transmit opportunities. Thus, step 332 is performed only when the electronic device is a priority device.

By way of example, where the priority value is a binary indicator of whether or not the electronic device is to operate in the priority device mode, then sub-step 331 may be performed when the binary indicator indicates that the electronic device is to operate in the priority device mode, otherwise sub-step 332 is performed.

As another example, where the priority value is an identifier of the electronic device (of the communication network) that is to operate in the priority device mode, then sub-step 332 may be performed when the priority value indicates that the electronic device (for which method 300 is performed) is to operate in the priority device mode and sub-step 331 may be performed otherwise (i.e., when any other electronic device is operate in the priority device mode).

The determination of whether or not the priority mode has a first value or a second value may be performed in a determination step 336. Step 336 effectively determines whether the electronic device is operating in the priority mode (i.e., when the priority value takes the second value) or not operating in the priority mode (i.e., when the priority value takes one of the set of one or more first values).

The method 300 also comprises a step 340 of responsive to a beacon signal over the shared communication medium, stepping through the transmit order sequence. In this way, the electronic device may operate in a similar manner to that previously described.

In some examples, step 340 may be performed by starting at a first position in the transmit order sequence and iteratively: beginning a timer; responsive to a data transmission by the electronic device or any other electronic device over the shared communication medium occurring before the timer reaches a transmit opportunity duration, waiting until the data transmission has ended before moving to a next position in the transmit order sequence; and responsive to a data transmission by the electronic device or any other electronic device over the shared communication medium occurring before the timer reaches the transmit opportunity duration, moving to a next position in the transmit order sequence responsive to the timer reaching the transmit opportunity duration.

In some examples, step 330 also comprises, responsive to a negative determination in sub-step 335 (i.e., when the priority mode indicator indicates that the communication network is not operating in the priority mode), performing a sub-step 339 of determining the one or more transmit opportunities for the electronic device to be only a single transmit opportunity. Thus, sub-step 339 determines only a single device position for the device.

A number of example approaches for performing sub-steps 331, 332 and 339 are hereafter described. The skilled person will appreciate that variants to these approaches are readily achieved, and that the action(s) performed in sub-step 331 will at least partially depend upon the action(s) performed in sub-step 332, and vice versa, to achieve a coherent and consistent transmit order sequence across each electronic device of the communication network.

Hereafter described examples of sub-steps 331, 332 and 339 make use of a numeric identifier for the electronic device. The numeric identifier differs from any numeric identifier of any of the one or more other electronic devices of the communication network. Thus, the numeric identifier may be unique amongst all electronic devices of the communication network. By way of example, the numeric identifier may comprise an integer value that is unique to the electronic device, amongst all electronic devices of the communication network.

In some examples, the numeric identifier indicates a position in a sequence of devices comprising the electronic device and the one or more other electronic devices of the communication network. For instance, the numeric identifier may be an integer within the range of from 0 to X−1 or from 1 to X (where X is the total number of electronic devices in the communication network).

Accordingly, the method 300 may comprise a step 350 of storing a numeric identifier for the electronic device. In such approaches, sub-steps 331, 332 and 339 may (when performed) determine the device position for each transmit opportunity (for the electronic device) responsive to the numeric identifier.

One approach to performing sub-step 339 is to determine the device position for the transmit opportunity of the electronic device to be equal to the position Y of the electronic device in the sequence of devices comprising the electronic device and the one or more other electronic devices. This aligns with pre-existing techniques and approaches for determining the transmit order sequence.

A number of example scenarios for performing sub-steps 331 and 332 are hereafter described. In these scenarios, the numeric identifier indicates the position Y of the electronic device in the sequence of devices comprising the electronic device and the one or more other electronic devices. Moreover, in these scenarios, it is assumed that only a single electronic device of the communication network operates in the priority mode, i.e., there is only a single priority device, For the purposes of illustration and understanding, the electronic device 102 is arbitrarily chosen to function as the single priority device.

In a first scenario, sub-step 331 may comprise setting the device position for the single transmit opportunity for the electronic device to be equal to 2Y, where Y is the position of the device in the sequence of devices.

In this first scenario, sub-step 332 may comprise determining the electronic device to have X+1 transmit opportunities, and therefore X+1 device positions (where X is the total number of electronic devices in the communication network). In particular, the device positions may include each Zth device position in the transmit order sequence, where Z takes each odd value from 1 to 2X as well as the device position at 2Y, where Y is the position of the device in the sequence of devices.

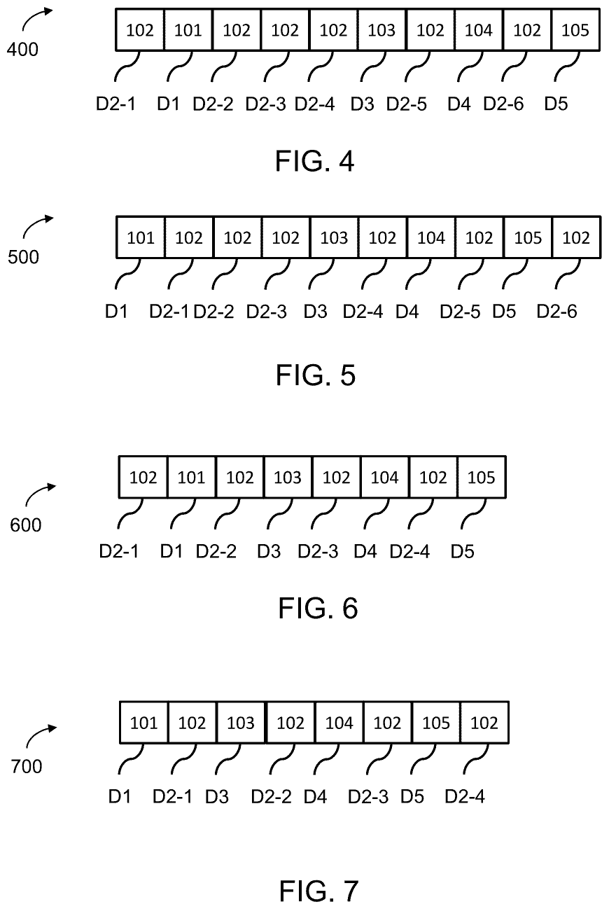

FIG. 4 illustrates an example transmit order sequence 400, produced by the approach disclosed in the first scenario, for the communication network 100 (FIG. 1) with the electronic device 102 functioning as the priority device. For the sake of clarity, an identifier for the electronic device associated with each device position is provided in FIG. 4.

The transmit order sequence includes at least one respective device position D1, D2-1, D2-2, D2-3, D2-4, D2-5, D2-6, D3, D4, D5 for each electronic device. A plurality of device positions is determined for the electronic device 102 operating in the priority device mode. Thus, at least one electronic device (which operates in the priority device mode) is associated with a plurality of transmit opportunities.

In a second scenario, sub-step 331 may comprise setting the device position for the single transmit opportunity for the electronic device to be equal to 2Y−1, where Y is the position of the device in the sequence of devices.

In this second scenario, sub-step 332 may comprise determining the electronic device to have X+1 transmit opportunities, and therefore X+1 device positions (where X is the total number of electronic devices in the communication network). In particular, the device positions may include each Zth device position in the transmit order sequence, where Z takes each even value from 1 to 2X as well as the device position at 2Y−1, where Y is the position of the device in the sequence of devices.

FIG. 5 illustrates an example transmit order sequence 500, produced by the approach disclosed in the second scenario, for the communication network 100 (FIG. 1) with the electronic device 102 functioning as the priority device. For the sake of clarity, an identifier for the electronic device associated with each device position is provided in FIG. 5.

The transmit order sequence includes at least one respective device position D1, D2-1, D2-2, D2-3, D2-4, D2-5, D2-6, D3, D4, D5 for each electronic device. A plurality of device positions is determined for the electronic device 102 operating in the priority device mode. Thus, at least one electronic device (which operates in the priority device mode) is associated with a plurality of transmit opportunities.

The first and second scenarios may be performed when the priority value for the electronic device comprises either a binary indicator of whether or not the electronic device is a priority device or an identifier of the electronic device that operates in the priority device mode.

In the following scenarios the priority value for the electronic device comprises an identifier of the electronic device that operates in the priority device mode.

In a third scenario, sub-step 331 may comprise setting the device position for the single transmit opportunity for the electronic device to be equal to M. In this third scenario, M is equal to 2N, where N is equal to the position of the electronic device in a modified sequence of devices. The modified sequence of devices is the sequence of devices excluding the priority device identified by the priority value. The value of N can be determined for the electronic device to be equal to the value of Y (when the electronic device is later in the sequence of devices than the priority device—as indicated by the priority value) or Y−1 (when the electronic device is earlier in the sequence of devices than the priority device).

In this third scenario, sub-step 332 may comprise determining the electronic device to have X−1 transmit opportunities, and therefore X−1 device positions (where X is the total number of electronic devices in the communication network). In particular, the device positions may include each Zth device position in the transmit order sequence, where Z takes each odd value from 1 to 2 (X−1).

FIG. 6 illustrates an example transmit order sequence 600, produced by the approach disclosed in the third scenario, for the communication network 100 (FIG. 1) with the electronic device 102 functioning as the priority device. For the sake of clarity, an identifier for the electronic device associated with each device position is provided in FIG. 6.

The transmit order sequence includes at least one respective device position D1, D2-1, D2-2, D2-3, D2-4, D3, D4, D5 for each electronic device. A plurality of device positions is determined for the electronic device 102 operating in the priority device mode. Thus, at least one electronic device (which operates in the priority device mode) is associated with a plurality of transmit opportunities.

In a fourth scenario, sub-step 331 may comprise setting the device position for the single transmit opportunity for the electronic device to be equal to M. In this fourth scenario, M is equal to 2N−1, where N is equal to the position of the electronic device in a modified sequence of devices. The modified sequence of devices excluding the priority device identified by the priority value. The value of N can be determined for the electronic device to be equal to the value of Y (when the electronic device is later in the sequence of devices than the priority device—as indicated by the priority value) or Y−1 (when the electronic device is earlier in the sequence of devices than the priority device).

In this fourth scenario, sub-step 332 may comprise determining the electronic device to have X−1 transmit opportunities, and therefore X−1 device positions (where X is the total number of electronic devices in the communication network). In particular, the device positions may include each Zth device position in the transmit order sequence, where Z takes each even value from 1 to 2 (X−1).

FIG. 7 illustrates an example transmit order sequence 700, produced by the approach disclosed in the fourth scenario, for the communication network 100 (FIG. 1) with the electronic device 102 functioning as the priority device. For the sake of clarity, an identifier for the electronic device associated with each device position is provided in FIG. 7.

The transmit order sequence includes at least one respective device position D1, D2-1, D2-2, D2-3, D2-4, D3, D4, D5 for each electronic device. A plurality of device positions is determined for the electronic device 102 operating in the priority device mode. Thus, at least one electronic device (which operates in the priority device mode) is associated with a plurality of transmit opportunities.

For the approaches described by the third and fourth examples, the total number of transmit opportunities (and therefore corresponding device positions) for the priority device is equal to the total number of transmit opportunities for all other electronic devices connected to the same communication medium (i.e., in the communication network).

In a fifth scenario, sub-step 331 may comprise setting the device position for the single transmit opportunity for the electronic device to be equal to M. In this fifth scenario, M is equal to 1+N+RND((N−1)/P), where N is equal to the position of the electronic device in a modified sequence of devices, P is a predetermined integer less than (X−1) and preferably an integer factor of (X−1), where X is the total number of electronic device in the communication network. The function RND(⋅) is a round-down function that rounds the enclosed value (⋅) down to the nearest integer that is lower than the enclosed value. As previously indicated, the modified sequence of devices excluding the priority device identified by the priority value. The value of N can be determined for the electronic device to be equal to the value of Y (when the electronic device is later in the sequence of devices than the priority device—as indicated by the priority value) or Y−1 (when the electronic device is earlier in the sequence of devices than the priority device).

In this fifth scenario, sub-step 332 may comprise determining the electronic device to have (X−1)/P transmit opportunities, and therefore (X−1)/P device positions (where X is the total number of electronic devices in the communication network and P is a predetermined integer that is less than (X−1) and is preferably an integer factor of (X−1)). In particular, the device positions include positions a₁, aₙ determined by:

$${a}_{1} = 1 \qquad ( 1 )$$

$${a}_{n} = {a}_{n - 1} + P + 1$$

where n takes each value between 2 and (X−1)/P.

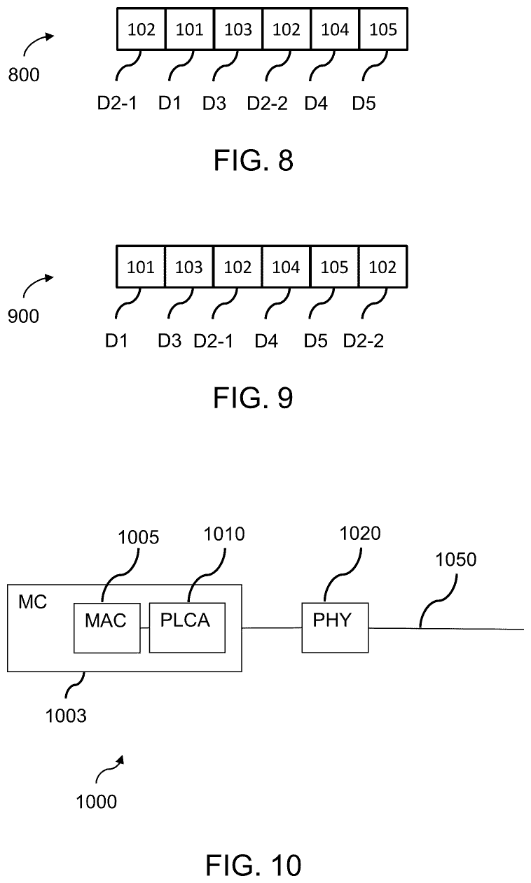

FIG. 8 illustrates an example transmit order sequence 800, produced by the approach disclosed in the fifth scenario, for the communication network 100 (FIG. 1) with the electronic device 102 functioning as the priority device. For the sake of clarity, an identifier for the electronic device associated with each device position is provided in FIG. 8.

The transmit order sequence includes at least one respective device position D1, D2-1, D2-2, D2-3, D2-4, D3, D4, D5 for each electronic device. A plurality of device positions is determined for the electronic device 102 operating in the priority device mode. Thus, at least one electronic device (which operates in the priority device mode) is associated with a plurality of transmit opportunities (namely: (X−1)/P transmit opportunities, where P is here equal to 2).

In a sixth scenario, sub-step 331 may comprise setting the device position for the single transmit opportunity for the electronic device to be equal to M. In this fifth scenario, M is equal to P+N+RND((N−1)/P), where N is equal to the position of the electronic device in a modified sequence of devices, P is a predetermined integer less than (X−1) and preferably an integer factor of (X−1), where X is the total number of electronic device in the communication network. The function RND(⋅) is a round-down function that rounds the enclosed value (⋅) down to the nearest integer that is lower than the enclosed value. As previously indicated, the modified sequence of devices excluding the priority device identified by the priority value. The value of N can be determined for the electronic device to be equal to the value of Y (when the electronic device is later in the sequence of devices than the priority device—as indicated by the priority value) or Y−1 (when the electronic device is earlier in the sequence of devices than the priority device).

In this sixth scenario, sub-step 332 may comprise determining the electronic device to have (X−1)/P transmit opportunities, and therefore (X−1)/P device positions (where X is the total number of electronic devices in the communication network and P is a predetermined integer that is less than (X−1) and is preferably an integer factor of (X−1)). In particular, the device positions include positions b₁, bₙ determined by:

$${b}_{1} = P + 1 \qquad ( 2 )$$

$${b}_{n} = {b}_{n - 1} + P + 1$$

where n takes each value between 2 and (X−1)/P.

Thus, every (P+1)th position in the transmit order sequence will be assigned to the electronics device operating in the priority mode (i.e., the priority device).

FIG. 9 illustrates an example transmit order sequence 900, produced by the approach disclosed in the sixth scenario, for the communication network 100 (FIG. 1) with the electronic device 102 functioning as the priority device. For the sake of clarity, an identifier for the electronic device associated with each device position is provided in FIG. 9.

The transmit order sequence includes at least one respective device position D1, D2-1, D2-2, D3, D4, D5 for each electronic device. A plurality of device positions is determined for the electronic device 102 operating in the priority device mode. Thus, at least one electronic device (which operates in the priority device mode) is associated with a plurality of transmit opportunities (namely: (X−1)/P transmit opportunities, where P is here equal to 2).

The foregoing provides a number of example approaches for determining a transmit order sequence at the device level. The approaches outlined above are performed or executed by a collision avoidance module for an electronic device of a communication network.

For improved contextual understanding, FIG. 10 illustrates a portion of an electronic device 1000 that includes a collision avoidance module 1010. This helps contextualize a possible location or communicative connection between the collision avoidance module and other components of the electronic device.

The electronic device here comprises a medium access module (also known as a medium access control (MAC)) 1005 and a transceiver module (PHY) 1020. An alternative label for the medium access module 1005 is an access control module. An alternative label for the transceiver module 1020 is a PHY chip or PHY module.

The medium access module 1005 is configured to control the access of the electronic device to the communication medium 1050, which may itself by embodied as an Ethernet cable. The medium access module 1005 may be integrated into a microcontroller 1003 or other processor of the electronic device, e.g., formed in a same chip or within a same package as the microcontroller and/or as a module or element of the microcontroller.

The transceiver module 1020 is configured for transmitting data over the shared communication medium, i.e., to perform the task of implementing physical layer functionality for modulating and demodulating data from the electronic device to/from the communication medium. Put another way, the transceiver module is configured to perform data delivery over the physical communication medium 1050 (e.g., generation of electrical signals for data delivery).

The collision avoidance module 1010 functions as an intermediary between the medium access module 1005 and the transceiver module 1020. In particular the collision avoidance module is configured to only permit transmission of data by the transceiver module during any transmit opportunity for the electronic device (as determined using a previously described approach).

The medium access module 1005, the collision avoidance module 1010 and the transceiver module may be connected by any suitable connection elements, such as a media-independent interface (MII) standard interface, examples of which are well known in the art.

In the illustrated example, the collision avoidance module 1010 is also integrated into the microcontroller 1003. However, this is not essential, and the collision avoidance module may instead by formed as/on an independent chip or as/on the same chip as the transceiver module 1030 (e.g., be integrated into a/the PHY chip).

In addition to the above-described examples, the following examples are disclosed.

Example 1: A collision avoidance module for an electronic device of a communication network, wherein the electronic device is configured to only transmit data to one or more other electronic devices of the communication network over a shared communication medium during any transmit opportunities for the electronic device, wherein the collision avoidance module is configured to:
a. store a priority mode indicator indicating whether or not the communication network is operating in a priority mode;
b. store a priority value;
c. determine, as a respective device position, a position in a transmit order sequence for each of one or more transmit opportunities for the electronic device, wherein each determined device position for the electronic device avoids conflict with any device position for any transmit opportunity of any of the one or more other electronic devices; and
d. responsive to a beacon signal over the shared communication medium, step through the transmit order sequence,
e. wherein the collision avoidance module is configured to, when the priority mode indicator indicates that the communication network is operating in the priority mode:
i. responsive to the stored priority value having one of a set of one or more first values, determine the one or more transmit opportunities to be only a single transmit opportunity; and
ii. responsive to the stored priority value having a second value, different to any of the set of one or more first values, determine the one or more transmit opportunities to be a plurality of transmit opportunities.

Example 2: The collision avoidance module of example 1, wherein the collision avoidance module is configured to, responsive to the priority mode indicator indicating that the communication network is operating in the priority mode and the stored priority value having the second value, determine the respective device positions for the plurality of transmit opportunities to be separated by at least one other position in the transmit order sequence.

Example 3: The collision avoidance module of example 2, wherein the collision avoidance module is configured to, responsive to the priority mode indicator indicating that the communication network is operating in the priority mode and the stored priority value having the second value, determine the respective device positions for the plurality of transmit opportunities to be separated by exactly one other position in the transmit order sequence.

Example 4: The collision avoidance module of any one of examples 1 to 3, wherein the collision avoidance module is configured to:
a. store a numeric identifier for the electronic device, wherein the numeric identifier differs from any numeric identifier of any of the one or more other electronic devices of the communication network; and
b. responsive to the priority mode indicator indicating that the communication network is operating in the priority mode and the stored priority value having one of the set of one or more first values, determine the device position for the single transmit opportunity responsive to the numeric identifier.

Example 5: The collision avoidance module of example 4, wherein the numeric identifier indicates a position in a sequence of devices comprising the electronic device and the one or more other electronic devices of the communication network.

Example 6: The collision avoidance module of any of examples 1 to 5, wherein:
a. the priority value identifies which, if any, of the electronic device and the one or more other electronic devices is a priority device in the communication network;
each first value identifies that one of the one or more other electronic devices is the priority device; and
a. the second value of the priority value indicates that the electronic device is the priority device.

Example 7: The collision avoidance module of example 6, when dependent upon example 5, wherein the collision avoidance module is configured to:
a. responsive to the priority mode indicator indicating that the communication network is operating in the priority mode and the stored priority value having one of a set of one or more first values, determine the device position to be the M-th position in the transmit order sequence, wherein:
b. M is equal to (2N) or (2N−1); and
c. N is equal to the position of the electronic device in a modified sequence of devices, being the sequence of devices excluding the priority device identified by the priority value.

Example 8: The collision avoidance module of any one of examples 1 to 7, further configured to store a node number value identifying a total number of the one or more other electronic devices, wherein the total number of the plurality of transmit opportunities comprises no more than the total number of the one or more other electronic devices.

Example 9: The collision avoidance module of example 8, wherein the total number of the plurality of transmit opportunities is equal to the total number of the one or more other electronic devices.

Example 10: The collision avoidance module of any one of examples 1 to 9, configured to:
a. store a transmit opportunity duration; and
b. step through the transmit order sequence by starting at a first position in the transmit order sequence and iteratively:
c. beginning a timer;
d. responsive to a data transmission by the electronic device or any other electronic device over the shared communication medium occurring before the timer reaches the transmit opportunity duration, waiting until the data transmission has ended before moving to a next position in the transmit order sequence; and
e. responsive to a data transmission by the electronic device or any other electronic device over the shared communication medium occurring before the timer reaches the transmit opportunity duration, moving to a next position in the transmit order sequence responsive to the timer reaching the transmit opportunity duration.

Example 11: The collision avoidance module of any one of examples 1 to 10, wherein the shared communication medium is an Ethernet cable.

Example 12: A communication arrangement for an electronic device comprising;
a. a medium access module for controlling access of the electronic device to the communication medium;
b. a transceiver module for transmitting data over the shared communication medium; and
c. the collision avoidance module of any one of examples 1 to 11, wherein the collision avoidance module is further configured to only permit transmission of data by the transceiver module during any transmit opportunity for the electronic device.

Example 13: A communication network comprising a plurality of electronic devices, each electronic device comprising the communication arrangement of example 12 and being communicatively connected by the shared communication medium.

Example 14: The communication network of example 13, wherein the shared communication medium is an Ethernet cable.

Example 15: A computer-implemented method for determining transmit opportunities for an electronic device, wherein the electronic device is configured to only transmit data to one or more other electronic devices of the communication network over a shared communication medium during a transmit opportunity for the electronic device, wherein the computer-implemented method comprises:
a. storing a priority mode indicator indicating whether or not the communication network is operating in a priority mode;
b. storing a priority value;
c. determining, as a respective device position, a position in a transmit order sequence for each of one or more transmit opportunities for the electronic device, wherein each determined device position for the electronic device avoids conflict with any device position for any transmit opportunity of any of the one or more other electronic devices; and
d. responsive to a beacon signal over the shared communication medium, stepping through the transmit order sequence,
e. wherein the computer-implemented method comprises, when the priority mode indicator indicates that the communication network is operating in the priority mode:
i. responsive to the stored priority value having one of a set of one or more first values, determining the one or more transmit opportunities to be only a single transmit opportunity; and
ii. responsive to the stored priority value having a second value, different to any of the set of one or more first values, determining the one or more transmit opportunities to be a plurality of transmit opportunities.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the modules, devices, arrangements and methods including its preferred embodiments as outlined in the present document may be used stand-alone or in combination with the other modules, devices, arrangements and methods disclosed in this document. In addition, the features outlined in the context of a module, device and/or arrangement are also applicable to a corresponding method, and vice versa. Furthermore, all aspects of the modules, devices, arrangements and methods outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A collision avoidance module for an electronic device of a communication network, wherein the electronic device is configured to transmit data to one or more other electronic devices of the communication network over a shared communication medium during transmit opportunities for the electronic device, wherein the collision avoidance module is configured to:
store a priority mode indicator indicating whether or not the communication network is operating in a priority mode;
store a priority value;
determine, as a respective device position, a position in a transmit order sequence for each of one or more transmit opportunities for the electronic device, wherein each determined device position for the electronic device avoids conflict with any device position for any transmit opportunity of any of the one or more other electronic devices; and
responsive to a beacon signal over the shared communication medium, step through the transmit order sequence,
wherein the collision avoidance module is configured to, when the priority mode indicator indicates that the communication network is operating in the priority mode:
responsive to the stored priority value having one of a set of one or more first values, determine the one or more transmit opportunities to be only a single transmit opportunity; and
responsive to the stored priority value having a second value, different to any of the set of one or more first values, determine the one or more transmit opportunities to be a plurality of transmit opportunities.

2. The collision avoidance module of claim 1, wherein the collision avoidance module is configured to, responsive to the priority mode indicator indicating that the communication network is operating in the priority mode and the stored priority value having the second value, determine the respective device positions for the plurality of transmit opportunities to be separated by at least one other position in the transmit order sequence.

3. The collision avoidance module of claim 2, wherein the collision avoidance module is configured to, responsive to the priority mode indicator indicating that the communication network is operating in the priority mode and the stored priority value having the second value, determine the respective device positions for the plurality of transmit opportunities to be separated by exactly one other position in the transmit order sequence.

4. The collision avoidance module of any one of claims 1 to 3, wherein the collision avoidance module is configured to:
store a numeric identifier for the electronic device, wherein the numeric identifier differs from any numeric identifier of any of the one or more other electronic devices of the communication network; and
responsive to the priority mode indicator indicating that the communication network is operating in the priority mode and the stored priority value having one of the set of one or more first values, determine the device position for the single transmit opportunity responsive to the numeric identifier.

5. The collision avoidance module of claim 4, wherein the numeric identifier indicates a position in a sequence of devices comprising the electronic device and the one or more other electronic devices of the communication network.

6. The collision avoidance module of claim 5, wherein:
the priority value identifies which, if any, of the electronic device and the one or more other electronic devices is a priority device in the communication network;
each first value identifies that one of the one or more other electronic devices is the priority device; and
the second value of the priority value indicates that the electronic device is the priority device.

7. The collision avoidance module of claim 6, wherein the collision avoidance module is configured to:
responsive to the priority mode indicator indicating that the communication network is operating in the priority mode and the stored priority value having one of a set of one or more first values, determine the device position to be the M-th position in the transmit order sequence, wherein:
M is equal to (2N) or (2N−1); and
N is equal to the position of the electronic device in a modified sequence of devices, being the sequence of devices excluding the priority device identified by the priority value.

8. The collision avoidance module of claim 1, further configured to store a node number value identifying a total number of the one or more other electronic devices, wherein the total number of the plurality of transmit opportunities comprises no more than the total number of the one or more other electronic devices.

9. The collision avoidance module of claim 8, wherein the total number of the plurality of transmit opportunities is equal to the total number of the one or more other electronic devices.

10. The collision avoidance module of claim 1, configured to:
store a transmit opportunity duration; and
step through the transmit order sequence by starting at a first position in the transmit order sequence and iteratively:
beginning a timer;
responsive to a data transmission by the electronic device or any other electronic device over the shared communication medium occurring before the timer reaches the transmit opportunity duration, waiting until the data transmission has ended before moving to a next position in the transmit order sequence; and
responsive to a data transmission by the electronic device or any other electronic device over the shared communication medium occurring before the timer reaches the transmit opportunity duration, moving to a next position in the transmit order sequence responsive to the timer reaching the transmit opportunity duration.

11. The collision avoidance module of claim 1, wherein the shared communication medium is an Ethernet cable.

12. A computer-implemented method for determining transmit opportunities for an electronic device, wherein the electronic device is configured to only transmit data to one or more other electronic devices of a communication network over a shared communication medium during a transmit opportunity for the electronic device, wherein the computer-implemented method comprises:
storing a priority mode indicator indicating whether or not the communication network is operating in a priority mode;
storing a priority value;
determining, as a respective device position, a position in a transmit order sequence for each of one or more transmit opportunities for the electronic device, wherein each determined device position for the electronic device avoids conflict with any device position for any transmit opportunity of any of the one or more other electronic devices; and
responsive to a beacon signal over the shared communication medium, stepping through the transmit order sequence,
wherein the computer-implemented method comprises, when the priority mode indicator indicates that the communication network is operating in the priority mode:
responsive to the stored priority value having one of a set of one or more first values, determining the one or more transmit opportunities to be only a single transmit opportunity; and
responsive to the stored priority value having a second value, different to any of the set of one or more first values, determining the one or more transmit opportunities to be a plurality of transmit opportunities.

13. A communication arrangement for an electronic device comprising;
a medium access module for controlling access of the electronic device to a shared communication medium, wherein the shared communication medium is coupled to at least one other electronic device that shares the shared communication medium with the electronic device;
a transceiver module for transmitting data over the shared communication medium; and
a collision avoidance module comprising
a memory to store a priority value associated with the electronic device, the priority value indicative of whether or not the electronic device is a priority device; and
a processor configured to, based on the priority value, determine one or more positions in a transmit opportunity sequence for use by the electronic device, wherein the transmit opportunity sequence includes a plurality of respective transmit opportunities over the shared communication that are allocated for use by respective ones of the electronic device and the at least one other electronic device,
the processor further configured to determine a single position in the transmit opportunity sequence for use by the electronic device when the priority value indicates that the electronic device is not the priority device and determine more than one position in the transmit opportunity sequence for use by the electronic device when the priority value indicates that the electronic device is the priority device.

14. The communication arrangement of claim 13, wherein the processor is configured to determine the single position or the more than one position in the transmit opportunity sequence based on a number of electronic devices coupled to the shared communication medium.

15. The communication arrangement of claim 13, wherein the processor is configured to determine the single position or the more than one position in the transmit opportunity sequence based on a pre-assigned position of the electronic device in the transmit opportunity sequence.

16. The communication arrangement of claim 13, wherein the processor is configured to determine the single position or the more than one position in the transmit opportunity sequence based on a number of positions in the transmit opportunity sequence.

17. The communication arrangement of claim 13, wherein the processor is configured to determine the more than one position in the transmit opportunity sequence by assigning odd numbered positions in the transmit opportunity sequence to the electronic device in addition to a pre-assigned position.

18. The communication arrangement of claim 13, wherein the processor is configured to determine the more than one position in the transmit opportunity sequence by assigning even numbered positions in the transmit opportunity sequence to the electronic device in addition to a pre-assigned position.

19. The communication arrangement of claim 13, wherein the processor is configured to determine the single position in the transmit opportunity sequence based on a pre-assigned position of the electronic device in the transmit opportunity sequence.
